(19) United States
(12) Patent Application Publication
(10) Pub. No.: US 2018/0025432 A1
(43) Pub. Date: Jan. 25, 2018

(54) PROPERTY OFFER

(71) Applicant: Lee Whitmore, Chesterfield, VA (US)

(72) Inventor: Lee Whitmore, Chesterfield, VA (US)

(21) Appl. No.: 15/655,124

(22) Filed: Jul. 20, 2017

Related U.S. Application Data
(60) Provisional application No. 62/493,888, filed on Jul. 20, 2016.

(51) Int. Cl. G06Q 40/08; G06Q 30/02; G06Q 40/06

(52) U.S. Cl. CPC G06Q 40/08; G06Q 40/06; G06Q 30/0206

(57) ABSTRACT

A method of compiling and presenting information include the steps of entering a plurality of inputs into a computational device, determining a plurality of outputs from the plurality of inputs, and outputting the plurality of outputs to a display device. The plurality of outputs include information on permanent life insurance and information on an asset, and the information on permanent life insurance is presented on the display device as a comparison with the information on the asset. The method may be implemented via a non-transitory computer-usable medium having stored therein computer-readable code.

### RELATED APPLICATIONS

This application claims priority from and incorporates by reference US Provisional Patent Application 62/493,888, filed on Jul. 20, 2016.

### FIELD OF THE INVENTION

The present invention generally relates to a method and a computer-implemented program for comparing permanent life insurance with an asset, and more particularly, to a method and computer-implemented program comparing permanent life insurance with real estate to better inform clients and prospective clients.

### BACKGROUND

Insurance agents are often disliked but they nonetheless play an important role in society by selling various kinds of insurance. Some of this insurance is mandated. For example, the government mandates hazard insurance on residential real estate primarily to protect the mortgage company's collateral for the value of the property and car insurance to protect against uninsured motorists. Some of this insurance is not mandated. For example, life insurance to protect a family from the hardships associated with losing a wage earner. Unlike mandated insurances, a study by the Life Insurance Management Research Association (LIMRA) in 2016 found twenty percent of American households with children under age 18 lack life insurance. Thus about thirty-seven million Americans are completely uninsured and at financial risk if the primary wage earner dies unexpectedly. This is 3.7 million fewer households being insured compared with the 2010 results and the number of uninsured is only expected to increase. Given this trend, one would expect insurance company to step in and fill an obviously unfilled need but this has not occurred. Rather, insurance companies have pretty much stopped providing incentives such as salary and allowances for new people to become insurance agents. The LIMRA estimates out of every 100 insurance agents new to the business only 15 are successful in 5 years. At a cost of approximately $300,000 to train a new insurance agent in the first three years alone, it is a losing financial proposition. As a result few companies are hiring new insurance agents. Instead, companies are trying to attract experienced proven insurance agents from other companies. Attracting an insurance agent with bonus is far better and far quicker than trying to train a new insurance agent at a far higher cost with only a 15% chance success rate. Thus with the average age of insurance agents increasing, the numbers of agents being trained on how to sell life insurance is dwindling. With fewer and fewer insurance agents to sell life insurance, the number of people without life insurance will only increase. Accordingly, there is a strong need in the art to improve the number of successful new insurance agents and to decrease the number of people without life insurance.

### SUMMARY OF THE INVENTION

An aspect of the present invention is to provide a method of compiling and presenting information include the steps of entering a plurality of inputs into a computational device, determining a plurality of outputs from the plurality of inputs, and outputting the plurality of outputs to a display device. The plurality of outputs include information on permanent life insurance and information on an asset, and the information on permanent life insurance is presented on the display device as a comparison with the information on the asset. The permanent life insurance may be universal life insurance or whole life insurance. The asset may be real property such as residential real estate, or may be chattel or personal property. The computational device may be a computer, or a networked computer. The computational device may be communicated with via the internet. The entering the plurality of inputs into a computational device may be performed automatically by filling in at least some of the plurality of inputs from a client (private) database or a predefined public database or both.

Another aspect of the present invention is to provide non-transitory computer-usable medium having stored therein computer-readable code for causing a processor of a computational device to compile and present information including a plurality of inputs, a plurality of outputs determined from the plurality of inputs, and a plurality of formatted outputs corresponding to the plurality of outputs suitable for output onto a display device. The plurality of formatted outputs includes information on permanent life insurance and an asset, and the plurality of formatted outputs produces a comparison between the information on permanent life insurance and the asset on the display device. The information on permanent life insurance may be information on universal life insurance or whole life insurance. The asset may be real property such as residential real estate. Alternatively the asset may be personal property or chattel. The computational device may be a networked computer, a personal computer, or a smart phone or any other suitable smart device. The computational device may be communicated with via the internet. At least one of the plurality of inputs is compiled automatically from a client (private) database or from a public database or both.

The present invention is advantageous in that it assists insurance agents more effectively explain permanent life insurance in a manner that is more easily understood by those unfamiliar with permanent life insurance. This will lead to higher success rates for new insurance agents and an increase in the use of permanent life insurance. The present invention also assists consumers in making a more informed decision about retirement and protecting heirs. The present invention also reduces the negative stigma associated with permanent life insurance by highlighting its similarities to property assets such as residential real estate. The increased use of permanent life insurance and the increased rate of new insurance agents being successful should stimulate the demand to recruit and train more new insurance agents.

### BRIEF DESCRIPTION OF THE DRAWINGS

The invention will be described in detail with reference to the following drawings in which like reference numerals refer to like elements wherein:

FIG. 1 illustrates an exemplary configuration of the invention where a local computation device is connected to an external public database and an external private database;

FIG. 2 illustrates an exemplary configuration of the invention where a local computation device is connected to an external public database and an internal private database;

FIG. 3 illustrates an exemplary configuration of the invention where a web based or networked computation device is connected to an external public database and an external private database; and

FIG. 4 illustrates an exemplary configuration of the invention where a web based or networked computation device is connected to an external public database and local computational device is connected to an internal private database.

### DETAILED DESCRIPTION

The present invention provides a method of compiling and presenting a comparison of permanent life insurance to property using a computational device. This may be implemented via a computer code. The method uses the date of birth of a person, a property value or a face value amount, an interest rate for loan, a term of mortgage and/or a mortgage premium payment, a start date for a mortgage, an insurance premium, a cash value at the end of term of an insurance policy, an illustrative/hypothetical rate of return, an amount of loan taken in first year after term, a tax bracket that client wants to assume or the actual tax bracket of the client, and a total loan taken over retirement years. Optionally, one or any combination of the name of client, a down payment amount, a property tax rate, pmi % per $100 and estimated or actual hazard insurance may all be input.

The inputs are used to calculate certain outputs. These outputs is a comparison of permanent life insurance with as asset such as real estate. More specifically, the comparison is made with the same current market value for the asset as the face value of the permanent life insurance policy. The comparison aids the insurance agent in showing the consumer the specific costs and benefits of permanent life insurance as property. For the real estate example, the output may include the premium payment of the permanent life insurance and may include the principle and interest to purchase the real estate. Additionally, the output for the real estate may include a down payment on the real estate, property taxes, insurance, closing costs, maintenance and purchaser mortgage insurance (PMI).

Calculators and average monthly costs needed to create a presentation for the insurance agent to use with the consumer include: an approved NAIC Illustration from a quality life insurance company, an amortization table calculation, national averages of PMI costs, national average of hazard insurance, local real estate property taxes, national cost of residential property maintenance, and projection calculator of investment hypothetical return. These calculators and costs are readily available.

The invention can be applied to a mortgage of any length including 10, 15. 20, 25 or 30 year mortgage. Comparisons using 30 years are more ideal than those using 10 years. The invention calculates the percentage of PMI and Property Taxes using the actual city or county the purchaser resides, it shows the national average cost of hazard insurance and maintenance for upkeep, it assumes average closing costs and calculates the percentage of insurance premium as it relates to the final mortgage payment and the additional cost of buying traditional real estate. The invention compares the equity in later years to the total outlay. The invention also calculates the difference in taxes on both (based on purchaser's actual current tax bracket), taking income at a later date as well as passing the permanent life insurance on to heirs. The comparison is a side by side comparison of the life insurance premium to asset (real estate) on a monthly basis as a percentage.

A sample comparison may be generated by using hypothetical numbers and dates. But, in order to populate an actual comparison for a client you would need their date of birth, certain financial information including income, tax bracket, current life insurance in-force on the person being used in the calculation, a little about their current health (e.g., estimated life span), their ability to fund now (e.g., how much for an initial payment) and over the long term (e.g., how much per month).

Some of the information for the comparison is public and routinely published. For example, companies and government entities routinely publish useful information that may be automatically accessed and used to provide a comparison according to the invention. For example, state and federal government entities publish their tax brackets and property tax rates, mortgage companies publish their mortgage rates, PMI % and hazard insurance costs.

Some of the information for the comparison is not public but may be located within a private database such as a company's client information database. Some of the client information in the company's client information database may be useful information that may be automatically accessed and used to provide a comparison according to the invention. Obviously, this will depend on the information contained within the database.

Permanent life insurance is an umbrella term for life insurance plans that do not expire (unlike term life insurance) and combine a death benefit with a savings portion. This savings portion can build a cash value against which the policy owner can borrow funds, or in some instances, the owner can withdraw the cash value to help meet future goals, such as paying for a child's college education. The two main types of permanent life insurance are whole and universal life insurance policies.

The invention can, in part, be thought of as an easier way to offer or explain permanent life insurance so the consumer has a way to understand the complexities of permanent life insurance by looking at it as an asset such as property. This means of understanding is very appropriate since permanent life insurance is technically property. The type of property most layman (i.e., non-insurance agents) have familiarity is residential real estate. Thus the predominant comparison will be to residential real estate. But other comparisons to other assets could be useful in certain contexts.

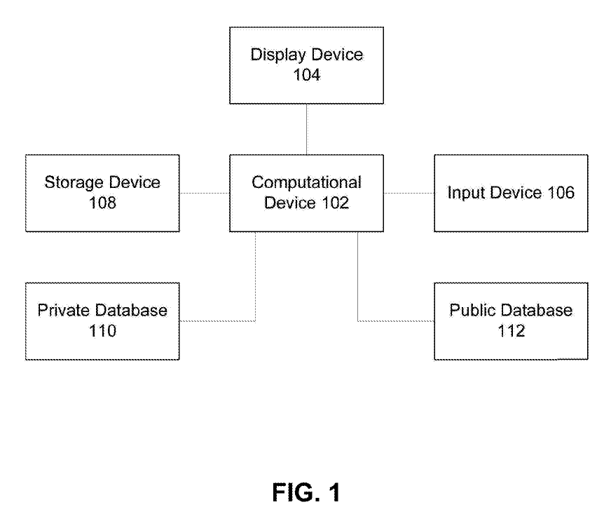

FIG. 1 illustrates an exemplary configuration of the invention where a local computation device is connected to an external public database and an external private database. More specifically, the invention shown in FIG. 1 includes a computational device 102, a display device 104, an input device 106, a storage device 108, a private database 110, and a public database 112. The computational device 102 may be a personal computer, a computer tablet, a smart phone or other smart device or any other suitable device. The display device 104 is typically a screen attached or associated with the computational device 102 such as a computer screen. The input device 106 is typically a computer keyboard of a computer but could also be a smart device screen, a microphone capable of converting speech to suitable inputs, or any other suitable device. The storage device 108 is any suitable memory device able to function as a non-transitory computer-usable medium having stored therein computer-readable code. It is this storage device 108 that stores the computer-readable code of the invention. The private database 110 is typically the client database of the person or company employing the invention and is stored on a memory storage device of some kind. Typically it would include the private information of the clients of an insurance agent or an insurance agent's company. The private database 110 may be located in the storage device 108 or may be located on a storage device separate from the storage device 108. The public database 112 is typically a third party database of published materials such as local tax rates, published insurance information, and the like and is stored on a memory storage device of some kind such as a computer server connected to the internet. The public database 112 is separate from the storage device 108 but may be copied in whole or in part into the storage device 108 for ease of use.

The computational device 102 may incorporate the display device 104, the input device 106, and the storage device 108 into a single device such as a personal computer or computer tablet. Alternatively, multiple devices may be used such as a computer with a separate display device such as computer screen or even a projection screen. The computational device 102 may be connected to the public database 112 via the internet or by some other connection means. The computational device 102 may be connected to the private database 110 via the internet, an intranet system, an Ethernet system, or any other suitable external connection means.

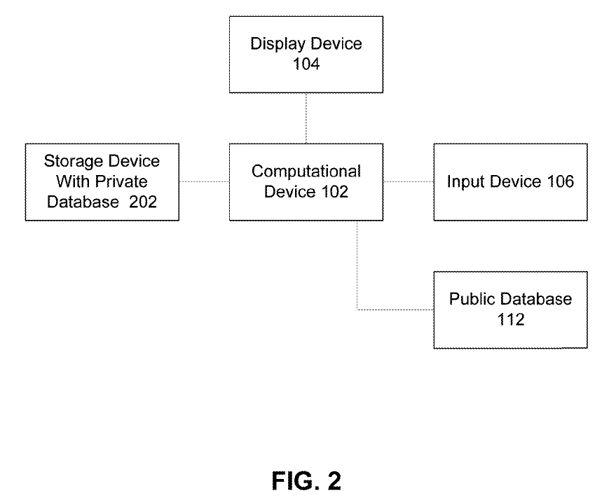

FIG. 2 illustrates an exemplary configuration of the invention where a local computation device is connected to an external public database and an internal private database. More specifically, the invention shown in FIG. 2 includes a computational device 102, a display device 104, an input device 106, a storage device with a private database 202, and a public database 112. FIG. 2 is similar to FIG. 1 except the private database 110 is incorporated into the storage device 108 forming a storage device with the private database 202. The exemplary embodiment of FIG. 2 avoid the need for an external connection to access information located within the private database 110.

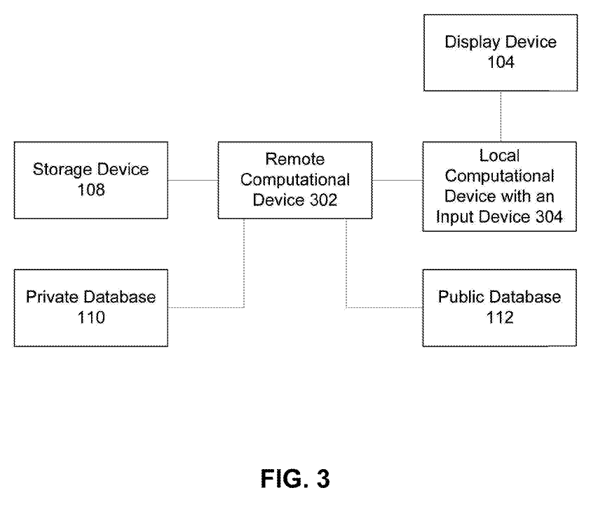

FIG. 3 illustrates an exemplary configuration of the invention where a web based or networked computation device is connected to an external public database and an external private database. More specifically, the invention shown in FIG. 3 includes a remote computational device 302, a display device 104, a local computational device with an input device 304, a storage device 108, a private database 110, and a public database 112. The remote computational device 302 will typically be a server in the web based context (web based context includes cloud computing) and a similar computational device in the networked context. However any suitable computational device work. The local computational device with an input device 304 may be connected to the display device 104 in the same manner as the computational device 102 of FIG. 1 is connected to the display device. But the local computational device with an input device 304 of FIG. 3 connects to the remote computational device 302 via an external connection. In the exemplary embodiment of FIG. 3, the remote computational device 302 may be connected to the private database 110 and the public database 112 via the internet or by some other connection means. Unlike the exemplary embodiments of FIG. 1 and FIG. 2, the computer-readable code of the invention execute on the remote computational device 302 rather than computational device 102 which is not remote but local.

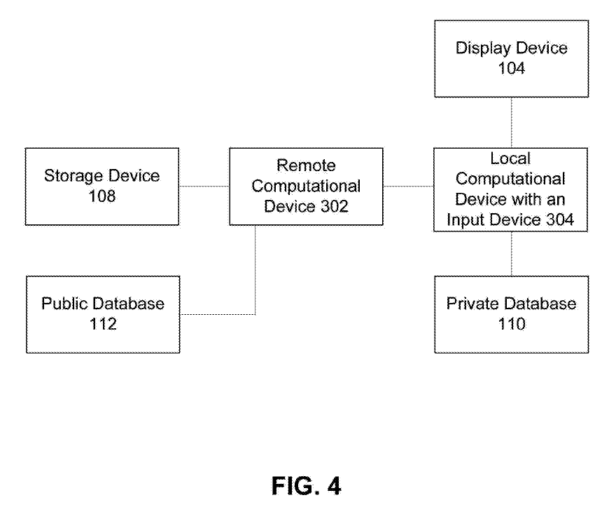

FIG. 4 illustrates an exemplary configuration of the invention where a web based or networked computation device is connected to an external public database and local computational device is connected to an internal private database. More specifically, the invention shown in FIG. 4 includes a remote computational device 302, a display device 104, a local computational device with an input device 304, a storage device 108, a private database 110, and a public database 112. FIG. 4 differs from FIG. 3 in that the private database is connected to the local computational device with an input device 304 instead of the remote computational device 302. In this exemplary embodiment, the local computational device with an input device 304 would locate the needed information from the private (client) database 110 and send it to the remote computation device 302.

A variety of other configurations of the invention may also be made.

The invention may be implemented in Excel™, PowerPoint™, as a web applicant, a smart device applicant, or in any other suitable program, language or platform.

The formatted output may be printed, text messaged, emailed or sent in any other suitable manner.

Although several embodiments of the present invention and its advantages have been described in detail, it should be understood that changes, substitutions, transformations, modifications, variations, permutations and alterations may be made therein without departing from the teachings of the present invention, the spirit and the scope of the invention being set forth by the appended claims.

What is claimed is:

1. A method of compiling and presenting information comprising the steps of:
entering a plurality of inputs into a computational device;
determining a plurality of outputs from the plurality of inputs; and
outputting the plurality of outputs to a display device;
wherein the plurality of outputs include information on permanent life insurance and information on an asset, and
wherein the information on permanent life insurance is presented on the display device as a comparison with the information on the asset.

2. The method of claim 1, wherein the permanent life insurance is universal life insurance or indexed universal life insurance.

3. The method of claim 1, wherein the permanent life insurance is whole life insurance.

4. The method of claim 1, wherein the asset is real property.

5. The method of claim 4, wherein the asset is residential real estate.

6. The method of claim 1, wherein the asset is chattel or personal property.

7. The method of claim 1, wherein the computational device is a computer.

8. The method of claim 1, wherein the computational device is a networked computer.

9. The method of claim 1, wherein the computational device is communicated with via the internet.

10. The method of claim 1, wherein the entering the plurality of inputs into a computational device includes automatically filling in at least some of the plurality of inputs from a client database.

11. The method of claim 1, wherein the entering the plurality of inputs into a computational device include automatically filling in at least some of the plurality of inputs from a predefined public database.

12. A non-transitory computer-usable medium having stored therein computer-readable code for causing a processor of a computational device to compile and present information comprising:
a plurality of inputs;
a plurality of outputs determined from the plurality of inputs; and
a plurality of formatted outputs corresponding to the plurality of outputs suitable for output onto a display device;
wherein the plurality of formatted outputs includes information on permanent life insurance and an asset, and
wherein the plurality of formatted outputs produces a comparison between the information on permanent life insurance and the asset on the display device.

13. The medium of claim 12, wherein the information on permanent life insurance is information on universal or indexed universal life insurance.

14. The medium of claim 12, wherein the information on permanent life insurance is information on whole life insurance.

15. The medium of claim 12, wherein the asset is real property.

16. The medium of claim 15, wherein the asset is residential real estate.

17. The medium of claim 12, wherein the computational device is a networked computer.

18. The medium of claim 12, wherein the computational device is communicated with via the internet.

19. The medium of claim 12, wherein at least one of the plurality of inputs is compiled automatically from a client database.

20. The medium of claim 12, wherein at least one of the plurality of inputs is compiled automatically from a public database.
